(19) United States
(12) Patent Application Publication
(10) Pub. No.: US 2025/0121586 A1
(43) Pub. Date: Apr. 17, 2025

(54) LAMINATED BODY HAVING RESIN LAYER AND METAL LAYER AND PRODUCTION METHOD FOR SAME

(71) Applicant: OSAKA UNIVERSITY, Osaka (JP)

(72) Inventors: Yuji OHKUBO, Osaka (JP); Kazuya YAMAMURA, Osaka (JP); Misa NISHINO, Osaka (JP)

(73) Assignee: OSAKA UNIVERSITY, Osaka (JP)

(21) Appl. No.: 18/687,110

(22) PCT Filed: Aug. 30, 2022
(86) PCT No.: PCT/JP2022/032538

§ 371 Date: Feb. 27, 2024

(30) Foreign Application Priority Data
Aug. 30, 2021 (JP) 2021-140261

(51) Int. Cl. B32B 15/08; B32B 15/20; B32B 37/00; B32B 37/06; B32B 37/10; B32B 37/18; B32B 38/00

(52) U.S. Cl. CPC B32B 15/08; B32B 15/20; B32B 2037/0092; B32B 37/06; B32B 37/10; B32B 37/182; B32B 38/0008; B32B 38/0036; B32B 2307/204; B32B 2307/538; B32B 2307/7376; B32B 2311/12; B32B 2327/18

(57) ABSTRACT

It is provided that a laminated body having high adhesiveness between a resin layer and a metal layer without roughening the surface of the resin layer or the metal layer or providing an intermediate layer between the resin layer and the metal layer. A laminated body comprising a resin layer and a metal layer, wherein the metal layer is stacked directly on a surface of the resin layer containing a fluorine-based resin, an adhesive strength between the resin layer and the metal layer is 0.7 N/mm or higher, and the metal layer has a surface roughness Sq of 0.2 μm or smaller.

### TECHNICAL FIELD

The present invention relates to a laminated body including a resin layer and a metal layer and a production method for the same.

### BACKGROUND ART

In recent years, since there has been demand for transmitting and receiving larger amounts of data at high speeds in various electronic devices, using high-frequency bands to increase transmission information capacity has been attracting attention, and especially the use of high-frequency waves of 30 GHz or higher, known as millimeter waves, has been attracting attention. However, when using high-frequency bands, while the transmission information capacity is very large, transmission loss in a transmission path tends to increase. When transmission loss increases, inconveniences such as electrical signal loss and longer signal delay times occur.

To reduce transmission loss, a fluorine-based resin having a low relative dielectric constant and also having a low dielectric loss tangent is used. Specifically, a laminated body including a resin layer containing the fluorine-based resin and a metal layer as a conductor is used in various applications using high-frequency bands.

In such a laminated body, electrical signals pass through the interface between the resin layer, which is a dielectric body, and the metal layer, which is a conductor, so that the transmission loss decreases as the interface is smoother. However, since the adhesiveness between the resin layer containing the fluorine-based resin and the metal layer is low, various treatments are performed to improve the adhesiveness between the resin layer containing the fluorine-based resin and the metal layer.

Patent Literature 1 describes a laminated body in which a flame treatment or a metallic sodium treatment is performed on a surface of a fluorine-based resin layer, and a surface of the fluorine-based resin layer subjected to the above treatment is adhered to a metal layer or the like using an adhesive. Patent Literature 2 describes a method for producing a laminated body in which a film base material and a metal foil are stacked after a surface treatment is performed on an adhesion surface of the metal foil to make the adhesion surface into a roughened surface. Patent Literature 3 describes performing graft polymerization of a monomer such as an acrylic monomer and a resin in a surface of a resin base material to form a graft polymerization layer, and then stacking a metal film on the graft polymerization layer.

### CITATION LISTS

### Patent Literatures

[PTL 1] Japanese Laid-Open Patent Publication No. S60-199032
[PTL 2] Japanese Laid-Open Patent Publication No. 2019-018403
[PTL 3] Japanese Laid-Open Patent Publication No. 2009-167323

### SUMMARY OF THE INVENTION

### Problems to be Solved by the Invention

In Patent Literatures 1 to 3, a roughening treatment is performed on the surface of the resin layer or the metal layer, or an adhesive or a graft polymerization layer is provided as an intermediate layer between the metal layer and the resin layer containing the fluorine-based resin. In Patent Literatures 1 to 3, the adhesive strength between the resin layer and the metal layer is increased, but transmission loss is increased due to the roughening of the surface of the resin layer or the metal layer, or the provision of the intermediate layer between the resin layer and the metal layer.

Meanwhile, when, in order to stack the metal layer directly on the surface of the resin layer containing the fluorine-based resin, a plasma treatment is performed on the resin layer, the metal layer is stacked on the resin layer, and the resin layer and the metal layer are heated and compressed, transmission loss can be reduced, but the adhesive strength between the resin layer and the metal layer becomes insufficient.

An object of the present invention is to provide a laminated body having high adhesiveness between a resin layer and a metal layer without roughening the surface of the resin layer or the metal layer or providing an intermediate layer between the resin layer and the metal layer.

### Solution to the Problems

In view of the above problems, the inventors of the present invention have conducted extensive studies. As a result, the inventors have found that, after a plasma treatment is performed on a surface of a resin layer, when the resin layer and a metal layer are merely stacked, and heated and compressed, the resin layer expands in the width direction and the length direction, which are perpendicular to the thickness direction, due to the heating and compressing, and the surface of the resin layer that is in contact with the metal layer is torn at various locations, thereby forming portions that have not undergone the plasma treatment, in the surface of the resin layer. Hereinafter, a specific description will be given using FIG. 1.

FIG. 1A is a cross-sectional view of the laminated body before the plasma treatment, and FIG. 1B is a cross-sectional view of the laminated body when the resin layer expands in the width direction and the length direction due to the heating and compressing after the plasma treatment. In FIG. 1, reference character 1 denotes the resin layer, reference character 2 denotes the metal layer, reference character 3 denotes the portions that have undergone the plasma treatment, in the surface of the resin layer, and reference character 4 denotes the portions that have not undergone the plasma treatment, in the surface of the resin layer. When the resin layer and the metal layer are heated and compressed, the resin layer expands in the width direction and the length direction which are perpendicular to the thickness direction, and the surface of the resin layer that is in contact with the metal layer is torn at various locations. Due to the tearing on the surface of the resin layer, it is considered that the resin that has not undergone the plasma treatment appears on the resin layer from the inside of the resin layer, and surfaces of the resin layer that have not undergone the plasma treatment as denoted by reference character 4 are formed. On the surface of the resin layer, the resin layer and the metal layer are almost not adhered to each other at the portions that have not undergone the plasma treatment, and thus it is considered that a situation in which the resin layer and the metal layer are easily peeled off starting from the portions that have not undergone the plasma treatment (especially the portions where a larger amount of the resin that has not undergone the plasma treatment appears from the inside of the resin layer) occurs, and the adhesive strength between the resin layer and the metal layer becomes insufficient.

The inventors of the present invention have found that by performing a predetermined plasma treatment and performing control such that the resin layer does not expand in the width direction and the length direction during heating and compressing, a state where the entire surface of the resin layer that is in contact with the metal layer has undergone the plasma treatment can be maintained even at the end of the heating and compressing, thereby increasing the adhesive strength between the resin layer and the metal layer, and thus have completed the present invention.

That is, the present invention has the following configuration.

[1] A laminated body comprising a resin layer and a metal layer, wherein the metal layer is stacked directly on a surface of the resin layer containing a fluorine-based resin, an adhesive strength between the resin layer and the metal layer is 0.7 N/mm or higher, and the metal layer has a surface roughness Sq of 0.2 μm or smaller.

[2] The laminated body according to the above [1], wherein the resin layer has a relative dielectric constant of 2.3 or lower at a frequency of 10 kHz and a dielectric loss tangent of 0.0006 or lower at a frequency of 10 KHz.

[3] The laminated body according to the above [1] or [2], wherein the resin layer contains a structural unit derived from tetrafluoroethylene.

[4] The laminated body according to any one of the above [1] to [3], wherein the metal layer contains at least one selected from the group consisting of copper, aluminum, iron, silver, and stainless steel.

[5] The laminated body according to any one of the above [1] to [4], wherein the metal layer has a thickness of 50 nm or larger.

[6] A method for producing a laminated body including a resin layer and a metal layer, the method comprising: performing a plasma treatment on a surface of the resin layer containing a fluorine-based resin, with a surface temperature of the resin layer being set to (melting point of the fluorine-based resin−150° C.) or higher; stacking the metal layer directly on the surface of the resin layer; and heating and compressing the resin layer and the metal layer, wherein an increase in a surface area of the resin layer due to the heating and compressing is 10% or less.

### Advantageous Effects of the Invention

When producing a laminated body by performing the predetermined plasma treatment on the resin layer and heating and compressing the resin layer and the metal layer, by performing control such that the resin layer does not expand in the width direction and the length direction due to the heating and compressing, high adhesive strength can be obtained even when the metal layer is stacked directly on the resin layer containing the fluorine-based resin.

In addition, the production cost can be reduced since the metal layer can be adhered directly to the surface of the resin layer containing the fluorine-based resin without roughening the surface of the resin layer containing the fluorine-based resin or the surface of the metal layer, providing a layer different from the resin layer containing the fluorine-based resin, or using an adhesive.

### BRIEF DESCRIPTION OF THE DRAWINGS

FIG. 1A is a cross-sectional view of a laminated body before a plasma treatment, and FIG. 1B is a cross-sectional view of the laminated body when a resin layer expands in a width direction and a length direction due to heating and compressing after the plasma treatment.

FIG. 2 shows conceptual diagrams of an atmospheric pressure plasma treatment apparatus, wherein FIG. 2A is a side view of the entirety thereof and FIG. 2B is a plan view showing the relationship between a bar-shaped electrode and a substrate.

### DESCRIPTION OF EMBODIMENTS

The laminated body of the present invention is a laminated body including a resin layer and a metal layer, in which the metal layer is stacked directly on a surface of the resin layer containing a fluorine-based resin (hereinafter simply referred to as “resin layer”). In the present specification, the fluorine-based resin refers to a resin containing a fluorine atom in a molecule.

### <Resin Layer>

From the viewpoint of reducing transmission loss, the resin layer preferably has a lower relative dielectric constant. Specifically, the resin layer has a relative dielectric constant of preferably 2.3 or lower, more preferably 2.2 or lower, and further preferably 2.1 or lower at a frequency of 10 KHz. From the viewpoint of reducing transmission loss, the resin layer preferably has a lower dielectric loss tangent. Specifically, the resin layer has a dielectric loss tangent of preferably 0.0006 or lower, more preferably 0.0004 or lower, further preferably 0.0003 or lower, and particularly preferably 0.0002 or lower at a frequency of 10 KHz.

Examples of the fluorine-based resin include polytetrafluoroethylene (PTFE), tetrafluoroethylene-hexafluoropropylene copolymer (FEP), and tetrafluoroethylene-perfluoroalkyl vinyl ether copolymer (PFA). From the viewpoint of decreasing the relative dielectric constant and the dielectric loss tangent, it is preferable to contain at least one of PTFE, PFA, and FEP, and it is more preferable to contain PTFE. From the viewpoint of decreasing the relative dielectric constant and the dielectric loss tangent, the amount of the resin other than PTFE, PFA, and FEP is preferably 30 parts by mass or smaller, more preferably 20 parts by mass or smaller, further preferably 10 parts by mass or smaller, particularly preferably 5 parts by mass or smaller, and most preferably 1 part by mass or smaller, per 100 parts by mass of the entire resin in the resin layer. One or more fluorine-based resins may be contained.

The resin layer is a copolymer of a difluoromethylene unit and at least one of a hexafluoropropylene unit, a perfluoroalkyl vinyl ether unit, a methylene unit, an ethylene unit and a perfluorodioxole unit, or polytetrafluoroethylene. The fluorine-based resin preferably contains a copolymer of a tetrafluoroethylene unit and a hexafluoropropylene unit, a perfluoroalkyl vinyl ether unit, an ethylene unit, or a perfluorodioxole unit, or polytetrafluoroethylene. From the viewpoint of decreasing the relative dielectric constant and the dielectric loss tangent, the resin layer preferably contains at least one selected from the group consisting of a tetrafluoroethylene unit, a hexafluoropropylene unit, and a perfluoroalkyl vinyl ether unit, and more preferably contains a tetrafluoroethylene unit. The total amount of the tetrafluoroethylene unit, the hexafluoropropylene unit, and the perfluoroalkyl vinyl ether unit in 100 mol % of the entire resin in the resin layer is preferably 50 mol % or higher, more preferably 70 mol % or higher, and further preferably 90 mol % or higher. In addition, the amount of the tetrafluoroethylene unit in 100 mol % of the entire resin in the resin layer is more preferably 30 mol % or higher, further preferably 50 mol % or higher, particularly preferably 70 mol % or higher, and particularly preferably 90 mol % or higher. The tetrafluoroethylene unit refers to a structural unit derived from tetrafluoroethylene, and the same applies to the other monomer units.

The resin layer may contain a resin other than the above-described fluorine-based resin. Examples of the resin other than the fluorine-based resin include: olefin-based resins such as polyethylene resins, polypropylene resins, and cycloolefin resins; polyester-based resins such as polyethylene terephthalate resins; polyimide-based resins; styrene-based resins such as styrene resins and syndiotactic polystyrene resins; aromatic polyether ketone-based resins such as polyether ether ketone resins, polyether ketone ketone resins, polyether ether ketone ketone resins, and polyphenylene ether resins; polyacetal-based resins; polyphenylene sulfide-based resins; bismaleimide triazine-based resins; and the like. From the viewpoint of decreasing the relative dielectric constant and the dielectric loss tangent, the amount of the resin other than the fluorine-based resin in 100 parts by mass of the entire resin in the resin layer is preferably 20 parts by mass or smaller, more preferably 10 parts by mass or smaller, further preferably 5 parts by mass or smaller, particularly preferably 1 part by mass or smaller, and most preferably 0 parts by mass (most preferably, the resin layer contains no resin other than the fluorine-based resin).

Generally, a resin is softer than a metal, and the resin layer is stacked along the irregularities of the surface of the metal layer during heating and compressing. Thus, a surface roughness Sq of the resin layer has the same value as a surface roughness Sq of the metal layer in Examples described later. It should be noted that, if the resin layer contains many inorganic fibers such as glass fibers or carbon fibers, the fluidity of the resin during heating and compressing may decrease, so that the surface roughness Sq of the resin layer may differ from the surface roughness Sq of the metal layer. However, a high-frequency current flows along the irregularities of the surface of the metal layer, so that, as long as the adhesive strength is 0.7 N/mm or higher, the metal layer does not have to be completely adhered to the resin layer, and there may be voids in part of the interface between the resin layer and the metal layer. The surface roughness Sq of the resin layer is not required to be as small as the surface roughness Sq of the metal layer described later, and, for example, it is sufficient that the surface roughness Sq of the resin layer is 20 μm or smaller.

The thickness of the resin layer is preferably 1 μm or larger. From the viewpoint of insulation and transmission loss reduction, the thickness of the resin layer is more preferably 5 μm or larger and further preferably 10 μm or larger. The upper limit of the thickness of the resin layer is not particularly limited, but when used as a flexible printed wiring board, the resin layer is preferably thinner, and the thickness of the resin layer is, for example, 5 mm or smaller.

The form of the resin layer that can be used in the present invention is not particularly limited as long as the resin layer has a shape that allows later-described plasma irradiation to be performed, and layers having various shapes and structures can be employed. Examples of the form of the resin layer include, but are not limited to, a rectangular shape, a spherical shape, a thin-film shape, and the like having surface shapes such as a flat surface, a curved surface, and a bent surface. In addition, the resin layer may be molded by various molding methods such as injection molding, melt extrusion, paste extrusion, compression molding, cutting molding, cast molding, and impregnation molding, depending on the properties of the fluorine-based resin. Moreover, the resin layer may have, for example, a dense continuous structure of resin as in a normal injection molded body, a porous structure, a non-woven fabric-like structure, or another structure, and is not particularly limited as long as the surface roughness Sq of the resin layer after lamination does not become excessively large.

In the resin layer, the surface on the side where the metal layer is stacked is subjected to a plasma treatment, and the metal layer is stacked directly on the surface of the resin layer subjected to the plasma treatment. By performing the plasma treatment, a laminated body having excellent adhesive strength can be obtained without roughening the surface of the resin layer or the metal layer or modifying the surfaces by means other than the plasma treatment. In addition, if the surface of the resin layer or the metal layer is roughened, a layer different from the resin layer and the metal layer is provided, or an adhesive is used, transmission loss is increased, but in the present invention, since the metal layer can be stacked directly on the surface of the resin layer subjected to the plasma treatment, transmission loss can be reduced. The plasma treatment will be described in detail later.

### <Metal Layer>

The metal used as the metal layer is not particularly limited, and may be selected as appropriate according to the application of the laminated body. For example, in the case where the laminated body is used in an electronic device, the material of the metal layer preferably contains at least one selected from the group consisting of copper, aluminum, iron, silver, and stainless steel, and more preferably contains copper. In addition, a metal foil may be used as the metal layer, and a metal film may be provided on the surface of the resin layer by vapor deposition or sputtering, that is, it is preferable to use a metal foil or a metal film, and it is more preferable to use a metal foil. In particular, since a copper foil such as a rolled copper foil and an electrolytic copper foil is often used as a metal layer in a general laminated body used in an electronic device or an electrical device, in the present invention as well, it is preferable to use a metal foil to produce a laminated body, and it is more preferable to use a copper foil to produce a laminated body. In the production of a laminated body, whether a metal foil or a metal film is used can be determined by the difference in fracture behavior when a shear test is performed. When a metal foil is used, a slip zone is generated around a crack, but when a metal film is used, no slip zone is generated around a crack.

Since it is not necessary to roughen the surface of the metal layer with sandpaper or the like, and transmission loss is reduced as the surface is smoother, the surface roughness Sq of the metal layer is preferably 0.3 μm or smaller, more preferably 0.2 μm or smaller, and further preferably 0.1 μm or smaller. The surface roughness Sq of the metal layer can be obtained by performing measurement in accordance with JIS B 0601, and the specific measurement method will be described later.

From the viewpoint of mechanical strength and the viewpoint of the maximum value of current, the thickness of the metal layer is preferably 50 nm or larger, more preferably 100 nm or larger, and further preferably 300 nm or larger. The upper limit of the thickness of the metal layer is not particularly limited, but is, for example, 1 mm or smaller. When transmitting signals to a printed board such as a flexible printed wiring board, it is most important to efficiently transmit signals, and the thickness of the metal layer is determined according to the frequency band used, the width of a metal wire, the thickness of the resin layer, and characteristic impedance.

### <Adhesive Strength>

In the laminated body of the present invention, the adhesive strength between the resin layer and the metal layer (hereinafter simply referred to as “adhesive strength”) is 0.7 N/mm or higher. The adhesive strength is preferably 0.8 N/mm or higher and more preferably 0.9 N/mm or higher. Since it is preferable that the adhesive strength is higher, the upper limit of the adhesive strength is not particularly limited, but is, for example, 10.0 N/mm or lower. The method for measuring the adhesive strength will be described later.

### <Production Method for Laminated Body>

Hereinafter, a production method for a laminated body including a resin layer and a metal layer will be described.

The production method for the laminated body includes: a step of performing a plasma treatment on a surface of the resin layer containing a fluorine-based resin, with a surface temperature of the resin layer being set to (melting point of the fluorine-based resin−150° C.) or higher; a step of stacking the metal layer directly on the surface of the resin layer; and a step of heating and compressing the resin layer and the metal layer. In addition, an increase in the surface area of the resin layer due to the heating and compressing is 10% or less.

### 1. Step of Performing Plasma Treatment on Surface of Resin Layer

The plasma treatment is performed on the surface of the resin layer with the surface temperature of the resin layer being set to (melting point of the fluorine-based resin-150° C.) or higher, that is, the surface of the resin layer is modified with the surface temperature of the resin layer being (melting point of the fluorine-based resin−150° C.) or higher. Such a surface temperature increases the mobility of the macromolecules of the polymer compound in the surface of the resin layer to be subjected to the plasma irradiation. Then, if the polymer compound in such a high mobility state is irradiated with plasma, when bonds between carbon atoms and between carbon atoms or other atoms in the polymer compound are cut, the carbon atoms whose bonds have been cut within each macromolecule cause a crosslinking reaction, and peroxide radicals can be sufficiently formed in the surface of the resin layer. In particular, when the fluorine-based resin forming the resin layer is PTFE, the surface temperature of the resin layer is preferably 180° C. or higher and more preferably 200° C. or higher. The upper limit of the surface temperature of the resin layer is not particularly limited, but may be, for example, (melting point+20° C.) or lower.

In a state where there is as little oxygen as possible in the vicinity of the surface of the resin layer, it is preferable to perform a plasma treatment on the surface of the resin layer to sufficiently form peroxide radicals in the surface of the resin layer, thereby modifying the surface of the resin layer. Specifically, it is preferable to perform a plasma treatment on the surface of the resin layer with the oxygen concentration near the surface of the resin layer (plasma irradiation region) being less than 0.5 vol % to produce a surface-modified resin layer. As for the plasma treatment, for example, the surface of the resin layer may be modified by performing a treatment with atmospheric pressure plasma in a state where the surface temperature of the resin layer is increased. By performing the atmospheric pressure plasma treatment, formation of dangling bonds due to defluorination in the surface of the resin layer is induced with radicals, electrons, ions, and the like contained in the plasma. Then, by exposure to the atmosphere for about several minutes to 10 minutes, a reaction with the water component in the atmosphere is caused, so that peroxide radicals and hydrophilic functional groups such as hydroxy groups and carbonyl groups are spontaneously formed in the dangling bonds.

In the present invention, the surface of the resin layer is preferably modified with atmospheric pressure plasma. As for the conditions for the treatment with the atmospheric pressure plasma, it is preferable to set the surface temperature of the resin layer within the above predetermined range and set an output power density within a predetermined range described later. The conditions that are employed in the technical fields for modifying the surface of a resin layer with plasma and under which atmospheric pressure plasma can be generated, can be employed as appropriate.

However, in the present invention, the treatment with the atmospheric pressure plasma is performed while the surface temperature of the resin layer is set in a predetermined temperature range in which the mobility of the macromolecules of the fluorine-based resin in the surface of the resin layer can be increased. Thus, when the surface temperature is increased only by the heating effect of the atmospheric pressure plasma treatment, it is preferable to perform the atmospheric pressure plasma treatment under conditions by which the heating effect is obtained.

To generate the atmospheric pressure plasma, for example, a high-frequency power supply having an applied voltage frequency of 50 Hz to 2.45 GHz may be used. An output power density (output power per unit area) may be, for example, 15 W/cm² or higher, although this cannot be said unconditionally since the output power density depends on a plasma generator, the constituent materials of the resin layer, etc. The upper limit of the output power density is not particularly limited, but may be, for example, 40 W/cm² or lower. In the case where a pulse output is used, a pulse modulation frequency of 1 to 50 kHz (preferably 5 to 30 kHz) and a pulse duty of 5 to 99% (preferably 15 to 80%, more preferably 25 to 70%) may be set. As a counter electrode, a cylindrical or plate-shaped metal coated on at least one side with a dielectric body can be used. The distance between opposed electrodes depends on other conditions, but from the viewpoint of plasma generation and heating, the distance is preferably 5 mm or shorter, more preferably 3 mm or shorter, further preferably 2 mm or shorter, and particularly preferably 1 mm or shorter. The lower limit of the distance between the opposed electrodes is not particularly limited, but is, for example, 0.5 mm or longer.

As the gas used to generate plasma, for example, a rare gas such as helium, argon, and neon, or a reactive gas such as oxygen, nitrogen, and hydrogen can be used. That is, as the gas used in the present invention, it is preferable to use only non-polymerizable gases.

As these gases, one or more rare gases may be used alone, or a mixed gas of one or more rare gases and an appropriate amount of one or more reactive gases may be used.

The plasma generation may be performed under a condition that the above gas atmosphere is controlled using a chamber, or may be performed under a completely open-air condition, for example, in which a rare gas is caused to flow to the electrode portions.

In the present invention, the surface of the resin layer on the side opposite to the plasma irradiation surface is hardly affected by the plasma treatment (the effects of hardness improvement, etc., are smaller than those on the plasma irradiation surface). Thus, various properties inherent in the fluorine-based resin (e.g., chemical resistance, weather resistance, heat resistance, electrical insulation, etc.) are not impaired and are sufficiently exhibited.

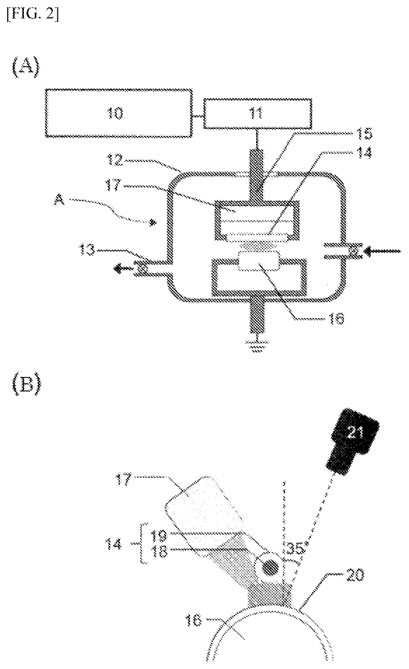

Hereinafter, one example of an embodiment of an atmospheric pressure plasma treatment applicable to the production method for the resin layer used in the present invention will be described mainly with the case where the resin layer is in the form of a sheet (thickness: 0.2 mm) made of PTFE, with reference to FIG. 2. However, the present invention is not limited to such an example, and may be naturally carried out in various configurations without departing from the gist of the present invention.

FIG. 2 shows a conceptual diagram of a capacitively coupled atmospheric pressure plasma treatment apparatus which is an example of the atmospheric pressure plasma treatment apparatus that can be used in the present invention. The atmospheric pressure plasma treatment apparatus A shown in FIG. 2A includes a high-frequency power supply 10, a matching unit 11, a chamber 12, a vacuum exhaust system 13, an electrode 14, an electrode elevating mechanism 15, a grounded cylindrical rotary stage and sample holder (hereinafter referred to as “rotary stage”) 16, and a rotary stage control part (not shown). The rotary stage 16 is placed so as to face the electrode 14. As the cylindrical rotary stage and the sample holder 16, for example, a stage and a holder made of an aluminum alloy can be used. As the electrode 14, an electrode having a bar shape and having a structure in which the surface of an inner tube 18 made of, for example, copper is coated with an outer tube 19 made of, for example, aluminum oxide (Al₂O₃) as shown in FIG. 2B, can be used.

The method for modifying the surface of the resin layer using the atmospheric pressure plasma treatment apparatus A shown in FIG. 2 is as follows. First, the resin layer is washed with an organic solvent such as acetone or with water such as ultrapure water if necessary, and then a sample (resin layer containing the fluorine resin) 20 in a sheet form is placed on the sample holder 16 in the chamber 12 as shown in FIG. 2A. Then, the air in the chamber 12 is sucked through the vacuum exhaust system 13 by a suction apparatus, which is not shown, to reduce the pressure in the chamber 12, and a gas for generating plasma is supplied into the chamber 12 (see an arrow in FIG. 2A) to adjust the inside of the chamber 12 to be atmospheric pressure. The sample 20 is not shown in FIG. 2A, but only in FIG. 2B described later. In addition, the atmospheric pressure does not have to be strictly 1013 hPa, and may be in a range of 700 to 1300 hPa.

With the apparatus as shown in FIG. 2A, a plasma treatment can be performed with the oxygen concentration near the surface of the resin layer (plasma irradiation region) being less than 0.5 vol %.

Next, the height (in the up-down direction in FIG. 2A) of the electrode elevating mechanism 15 is adjusted to move the electrode 14 to a desired position. By adjusting the height of the electrode elevating mechanism 15, the distance between the electrode 14 and the surface (upper surface) of the sample 20 can be adjusted. The distance between the electrode 14 and the surface of the sample 20 is preferably 5 mm or shorter and more preferably 2 mm or shorter. In particular, in the case where the surface temperature of the resin layer is controlled to be in a specific range by natural temperature rise due to the plasma treatment, the distance is particularly preferably 1.0 mm or shorter. As a matter of course, to move the sample 20 by rotation of the rotary stage 16, the electrode 14 and the sample 20 should not be brought into contact with each other.

Moreover, by rotating the rotary stage 16, a desired part of the surface of the resin layer can be irradiated with plasma. For example, the rotation speed of the rotary stage 16 is preferably 1 to 3 mm/sec, but the present invention is not limited to such an example. The plasma irradiation time to the sample 20 can be adjusted, for example, by varying the rotation speed of the rotary stage 16 or by repeatedly rotating the rotary stage 16 a desired number of times.

The high-frequency power supply 10 is operated while the rotary stage 16 is moved to move the sample 20, whereby plasma is generated between the electrode 14 and the rotary stage 16 and a desired area of the surface of the sample 20 is irradiated with the plasma. In this case, glow discharge can be generated under dielectric barrier discharge conditions by using, for example, a power supply having an applied voltage frequency and an output power density as described above as the high-frequency power supply 10, and using, for example, an electrode made of alumina-coated copper and a sample holder made of an aluminum alloy. Thus, peroxide radicals can be produced stably in the surface of the resin layer. Formation of dangling bonds due to defluorination in the surface of the PTFE sheet is induced with radicals, electrons, ions, and the like contained in the plasma, and by exposure to the air remaining in the chamber or clean air after the plasma treatment, a reaction with the water component and the like in the air is caused, whereby the peroxide radicals are introduced. Moreover, in the dangling bonds, hydrophilic functional groups such as hydroxy groups and carbonyl groups can be spontaneously formed in addition to peroxide radicals.

The intensity of the plasma with which the surface of the resin layer is irradiated can be adjusted as appropriate on the basis of various parameters of the above-described high-frequency power supply, the distance between the electrode 14 and the surface of the resin layer, etc. The above-described preferable conditions (applied voltage frequency, output power density, pulse modulated frequency, pulse duty, etc.) for the atmospheric plasma generation are effective particularly in the case where the resin layer is in the form of a sheet made of PTFE. Moreover, it is also possible to control the surface of the resin layer to be in a specific temperature range by adjusting the integrated irradiation time to the surface of the resin layer in accordance with the output power density. For example, in the case where the applied voltage frequency is 5 to 30 MHz, the distance between the electrode 14 and the surface of the resin layer is 0.5 to 2.0 mm, and the output power density is 15 to 30 W/cm², the integrated time of irradiation of the surface of the resin layer is preferably 50 seconds to 3300 seconds, more preferably 250 seconds to 3300 seconds, and particularly preferably 550 seconds to 2400 seconds. Particularly preferably, the surface temperature of the resin layer in the form of a sheet made of PTFE is 210 to 327° C., and the irradiation time is 600 to 1200 seconds. In the case where the irradiation time is excessively long, the effect brought about by the heating tends to be exhibited. The plasma irradiation time means the integrated time of irradiation of the surface of the resin layer with plasma, and it is sufficient that the surface temperature of the resin layer is (melting point-150° C.) or higher at least partially during the plasma irradiation time. For example, it is sufficient that the surface temperature of the resin layer is (melting point-150° C.) or higher over ½ or longer (preferably ⅔ or longer) of the plasma irradiation time. In any embodiment, by adjusting the surface temperature of the resin layer to be in the above range, the mobility of PTFE molecules in the surface of the resin layer is improved, and the probability of forming carbon-carbon bonds by binding of carbon atoms of carbon-fluorine bonds in PTFE molecules broken by plasma to carbon atoms in other PTFE molecules generated in the same manner is remarkably improved, so that the surface hardness can be improved.

Moreover, heating means for heating the sample 20 can be additionally provided. A heat ray irradiation device such as a halogen heater 17 may be placed in the vicinity of the electrode 14, as shown in FIG. 2B, in order to directly heat the surface of the resin layer (sample 20), a heating device for heating the above-mentioned gas in the chamber 12 and a circulation device equipped with a stirring blade or the like for circulating the heated gas in the chamber 12 may be placed in the chamber 12 in order to increase the environmental temperature in the chamber 12, the heating means may be placed on the rotary stage 16 in order to heat the sample 20 from the lower surface side, or these devices may be used in combination. The heating temperature by the heating means may be set and controlled as appropriate in consideration of the properties of the fluorine-based resin forming the resin layer, the form of the molded body, the heating effect by plasma treatment, etc. It is also preferable to preheat the molded body, before operating the high-frequency power supply 10, such that the temperature of the molded body is a desired temperature at the time of plasma irradiation.

Moreover, the surface temperature of the molded body during plasma treatment can be measured by using a radiation thermometer 21 as shown in FIG. 2B or using a temperature measurement seal.

### 2. Step of Stacking Metal Layer on Resin Layer and Step of Heating and Compressing Resin Layer and Metal Layer

After the above-described step of performing the plasma treatment on the surface of the resin layer, by performing the step of stacking the metal layer directly on the surface of the resin layer and the step of heating and compressing the resin layer and the metal layer, the laminated body can be obtained. Specifically, when the metal layer and the surface-modified resin layer are placed into a mold and thermo-compressed (heated and pressurized) in a state where the surface of the metal layer and the modified surface of the surface-modified resin layer are in contact with each other, both layers can be directly joined, and a joined body (laminated body) of the resin layer and the metal layer is obtained. For the thermo-compression, a heating and pressurizing treatment may be performed for about 5 to 40 minutes at a heating temperature of 200 to 400° C. and a pressure of 0.1 to 20 MPa, using a hot press machine or the like, for example. If both layers have a sheet-like shape, both layers may be stacked and compression-molded.

The mechanism by which the resin layer and the metal layer are joined (adhered) and good adhesive strength can be achieved by performing the plasma treatment at high power is considered to be as follows, but is not limited to the following mechanism.

By performing the plasma treatment at high power on the surface of the resin layer, more C—OH and COOH groups (carboxyl groups) are formed due to peroxide radicals introduced in the surface of the resin layer than when a plasma treatment is performed at low power. As a result, it is considered that not only the surface of the resin layer can be modified but the surface of the resin layer can also be hardened, thus enhancing the adhesive strength between the resin layer and the metal layer.

However, even if the plasma treatment described in the above 1. is performed, it is not possible to exhibit good adhesive strength between the resin layer and the metal layer simply by stacking the resin layer and the metal layer and heating and compressing the resin layer and the metal layer.

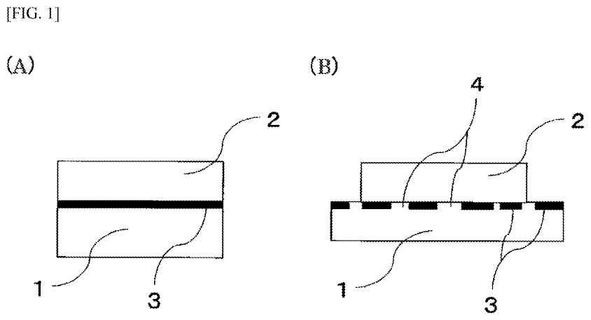

FIG. 1A is a cross-sectional view of the laminated body before the plasma treatment, FIG. 1B is a cross-sectional view of the laminated body after the plasma treatment, and the reason why the adhesive strength between the resin layer and the metal layer decreases when the resin layer expands in the width direction and the length direction during heating and compressing has been described above. As described above, in the present invention, by performing the plasma treatment described in the above 1, and by suppressing expansion of the resin layer in the width direction and the length direction during heating and compressing, a state where the entire surface of the resin layer that is in contact with the metal layer has undergone the plasma treatment can be maintained even at the end of the heating and compressing, and therefore, the adhesive strength between the resin layer and the metal layer can be increased.

The method for suppressing expansion of the resin layer in the width direction and the length direction is not particularly limited, and for example, a frame mold having the same size as the resin layer in the width direction and the length direction may be placed on the metal layer, the resin layer may be placed inside the frame mold, and then heating and compressing may be performed. The material of the frame mold is not particularly limited as long as the material is a material that does not expand at all or almost not at all under the above conditions of heating and compressing, and examples of the material include metals such as copper and stainless steel and resins including glass fibers. The thickness of the frame mold may be substantially the same thickness as that of the resin layer, or may be larger than that of the resin layer. In the case of a frame mold thicker than the resin layer, for example, a method in which a plate made of a material that does not expand at all or almost not at all under the above conditions of heating and compressing (hereinafter simply referred to as “plate”) is placed on the resin layer inside the frame mold is employed in order to smooth the surface of the resin layer on the side where the metal layer is not stacked. The above plate may further be placed on the frame mold, and heating and compressing may be performed. Even in the case of using the plate, heating and compressing is performed in a state where the unmodified surface of the resin layer and the surface of the plate are in contact with each other, so that, as shown in Comparative Example 2 below, the unmodified surface of the resin layer is almost not adhered to the plate, and does not affect the production of the laminated body of the resin layer and the metal layer.

With the above production method, the laminated body can be produced with almost no expansion of the resin layer in the width direction and the length direction due to the heating and compressing, that is, with the increase in the surface area of the resin layer due to the heating and compressing being reduced to 10% or less, and even when the metal layer is stacked directly on the resin layer, high adhesiveness can be exhibited. In Examples described later as well, the resin layer hardly expands in the width direction and the length direction due to the heating and compressing, and the increase in the surface area of the resin layer due to the heating and compressing is much less than 10%.

AFM-IR, which is an apparatus having a combination of the surface form observation function of an atomic force microscope (AFM) and the functional group identification function of infrared spectroscopy (IR), has a very high spatial resolution of about 10 nm, and can clarify not only information on surface form and but also the distribution of functional groups that are present in the surface. When a cross-section of the laminated body of the present invention (for example, a laminated body of a PTFE sheet and a copper foil described later in Examples, etc.) is analyzed by using AFM-IR, not only the materials forming the laminated body but also the surface modification depth by plasma treatment and interface roughness can be specified, thereby enabling reverse engineering. Therefore, by using the above apparatus, it is possible to identify that no surface modification other than a plasma treatment has been performed on the surface of the resin layer on the side where the metal layer is stacked.

The present application claims the benefit of priority to Japanese Patent Application No. 2021-140261 filed on Aug. 30, 2021. The entire contents of the specifications of Japanese Patent Application No. 2021-140261 filed on Aug. 30, 2021 are hereby incorporated by reference.

### EXAMPLES

Hereinafter, the present invention will be explained more concretely with reference to examples. The present invention should not be considered as being limited by the following examples, and, of course, modifications can be made appropriately without departing from the context mentioned above and below, and all of such modifications are within the technical scope of the present invention.

### <Adhesive Strength>

Using a digital force gauge (ZP-200N, manufactured by IMADA SEISAKUSHO CO., LTD.) and a motorized stand (MX-500N, manufactured by IMADA SEISAKUSHO CO., LTD.) in combination, a copper foil was fixed with two stainless steel bars, then a grasping margin of PTFE was pinched with upper chucks, and a PTFE sheet was pulling up in a direction perpendicular to the copper foil to conduct a 90-degree peeling test. The force acting between the PTFE sheet and the copper foil was measured with a load cell set at 1 kN and at a tensile speed of 60 mm/min, and an adhesive strength was calculated by dividing the measured value (unit: N) by the sample width (unit: mm).

### <Surface Roughness Sq>

Using a confocal laser microscope (OLS4500, manufactured by Olympus Corporation), a surface roughness (root mean square roughness) Sq was measured in an approximately 640 μm square range of a copper foil.

### Example 1

A laminated body in which a copper foil was stacked directly on a surface of a PTFE sheet was produced as follows.

### (1) Cleaning

At Nitto Denko Corporation, a PTFE sheet (NITOFLON No. 900UL) cut to a thickness of 0.2 mm was cut into a certain size (width: 4.5 cm× length: 7 cm) to prepare a resin layer. The resin layer was ultrasonically cleaned in acetone for 1 minute and then ultrasonically cleaned in pure water for 1 minute. Then, the pure water adhering to the PTFE sheet was removed by spraying nitrogen gas (purity: 99% or more) with an air gun. When the relative dielectric constant and the dielectric loss tangent of the above PTFE sheet were measured under conditions of a temperature of 23° C., a humidity of 50%, and a frequency of 10 kHz, the relative dielectric constant was lower than 2.1, and the dielectric loss tangent was 0.0002.

### (2) Plasma Treatment

The surface of the PTFE sheet subjected to the cleaning in the above (1) was modified with plasma by using a plasma generator (product name K2X02L023, manufactured by Meisyo Kiko Co., Ltd.,) having the configuration shown in FIG. 2.

As the high-frequency power supply of the plasma generator, a power supply having an applied voltage frequency of 13.56 MHz was used. As the electrode, an electrode having a structure in which a copper tube having an inner diameter of 1.8 mm, an outer diameter of 3 mm, and a length of 165 mm was coated with an alumina tube having an outer diameter of 5 mm, a thickness of 1 mm, and a length of 145 mm, was used. As the sample holder, a holder made of an aluminum alloy and having a cylindrical shape with a diameter of 50 mm and a width of 3.4 cm was used. The PTFE sheet was placed on the upper surface of the sample holder, and the distance between the surface of the resin layer and the electrode was set to be 1.0 mm.

A chamber was sealed, the pressure thereof was reduced to 10 Pa with a rotary pump, and then helium gas was introduced into the chamber until the pressure reached the atmospheric pressure (1013 hPa). Thereafter, the high-frequency power supply was set such that the output power density thereof was 19.1 W/cm², and a scanning stage was set so as to move at a movement speed of 2 mm/sec such that the electrode passed the scanning stage over 30 mm in the longitudinal direction of the resin layer. Thereafter, the high-frequency power supply was operated, the scanning stage was moved, and plasma irradiation was performed for 600 seconds in a range with width: 1.0 cm×length: 3.4 cm. The plasma irradiation time was adjusted on the basis of the number of times of reciprocation of the scanning stage by 30 mm in the longitudinal direction. In addition, when the oxygen concentration near the surface of the PTFE sheet (plasma irradiation region) was measured by using a Zirconia oxygen analyzer LC-300 manufactured by Toray Engineering Co., Ltd., the oxygen concentration was 25.7 ppm and significantly lower than 0.5 vol %. Then, when the surface temperature of the resin layer during plasma treatment was measured by a radiation thermometer (FT-H40K and FT-50A, manufactured by KEYENCE CORPORATION), the surface temperature was 203° C.

### (3) Step of Contacting and Adhering PTFE Sheet and Copper Foil

At room temperature, a copper foil having a width of 5 cm, a length of 6 cm, a thickness of 0.5 mm, and a surface roughness Sq of 0.1 μm was placed on the surface of a mold (A) having a width of 10 cm, a length of 10 cm, and a thickness of 10 mm, and a PTFE frame including a glass cloth and having a thickness of 0.23 mm (hereinafter referred to as GC-PTFE frame) was placed thereon. The GC-PTFE frame had a hole having a width of 1 cm and a length of 4 cm such that the PTFE sheet cut to a width of 1 cm, a length of 4 cm, and a thickness of 0.2 mm, which had been subjected to the above-described plasma treatment was able to be provided therein, and the PTFE sheet was fitted into the hole. When the PTFE sheet was fitted into the hole, the PTFE sheet and the copper foil were in contact with each other. The reason why the PTFE sheet was fitted into the hole provided in the GC-PTFE frame is to suppress expansion of the PTFE sheet in the width direction and the length direction. Next, a SUS foil (A) having a width of 1 cm, a length of 4 cm, and a thickness of 0.05 mm was placed on the PTFE sheet. Then, a SUS foil (B) having a width of 5 cm, a length of 6 cm, and a thickness of 0.05 mm was placed on the SUS foil (A) so as to cover the entire SUS foil (A). Finally, a mold (B) having the same size as the mold (A) was placed on the SUS foil (B) to prepare a mold in which the PTFE sheet, etc., were sandwiched.

The mold in which the PTFE sheet, etc., were sandwiched was set between upper and lower plates of a hot press machine (high temperature hot press machine H400-15 manufactured by AS ONE CORPORATION) heated to 320° C., the distance between the upper and lower plates was adjusted to a height where the mold (A) and the mold (B) were in contact with the plates, and then the mold (A) and the mold (B) were waited for to reach 320° C. After 320° C. was reached, the pressure was adjusted to 6.5 MPa and the mold (A) and the mold (B) were left for 10 minutes. Then, the mold was taken out of the hot press machine and allowed to stand until room temperature was reached, to obtain a laminated body in which the copper foil was stacked directly on the surface of the PTFE sheet. The adhesive strength between the PTFE sheet and the copper foil was 0.94 N/mm.

### Comparative Example 1

A laminated body was produced in the same manner as Example 1, except that the high-frequency power supply was set such that the output power density was 7.4 W/cm² in the plasma treatment in the above (2). When the surface temperature of the resin layer during the plasma treatment was measured by a radiation thermometer (FT-H40K and FT-50A, manufactured by KEYENCE CORPORATION), the surface temperature was 95° C., and the plasma treatment was carried out at a lower temperature than that of the plasma treatment in the above (2) in Example 1. The adhesive strength between the PTFE sheet and the copper foil was 0.22 N/mm.

### Comparative Example 2

A laminated body was produced in the same manner as Example 1, except that the plasma treatment in the above (2) was not performed. The adhesive strength between the PTFE sheet and the copper foil was 0.05 N/mm.

### Comparative Example 3

A laminated body was produced in the same manner as Example 1, except that only the laminated body of the PTFE sheet and the copper foil was set between the upper and lower plates of the hot press machine in a state where the PTFE sheet and the copper foil were in contact with each other without using the GC-PTFE frame and the SUS foils (A) and (B) in the above (3). The adhesive strength between the PTFE sheet and the copper foil was 0.10 N/mm.

### DESCRIPTION OF THE REFERENCE CHARACTERS

1 resin layer
2 metal layer
3 portion that has undergone plasma treatment
4 portion that has not undergone plasma treatment
5 high-frequency power supply
11 matching unit
12 chamber
13 vacuum exhaust system
14 electrode
15 electrode elevating mechanism
16 cylindrical rotary stage and sample holder
17 halogen heater
18 inner tube
19 outer tube
20 sample (resin layer containing fluorine resin)
21 radiation thermometer

1. A laminated body comprising a resin layer and a metal layer, wherein
the metal layer is stacked directly on a surface of the resin layer containing a fluorine-based resin,
an adhesive strength between the resin layer and the metal layer is 0.7 N/mm or higher, and
the metal layer has a surface roughness Sq of 0.2 μm or smaller.

2. The laminated body according to claim 1, wherein the resin layer has a relative dielectric constant of 2.3 or lower at a frequency of 10 kHz and a dielectric loss tangent of 0.0006 or lower at a frequency of 10 kHz.

3. The laminated body according to claim 1, wherein the resin layer contains a structural unit derived from tetrafluoroethylene.

4. The laminated body according to claim 1, wherein the metal layer contains at least one selected from the group consisting of copper, aluminum, iron, silver, and stainless steel.

5. The laminated body according to claim 1, wherein the metal layer has a thickness of 50 nm or larger.

6. A method for producing a laminated body including a resin layer and a metal layer, the method comprising:
performing a plasma treatment on a surface of the resin layer containing a fluorine-based resin, with a surface temperature of the resin layer being set to (melting point of the fluorine-based resin−150)° C. or higher;
stacking the metal layer directly on the surface of the resin layer; and
heating and compressing the resin layer and the metal layer, wherein
an increase in a surface area of the resin layer due to the heating and compressing is 10% or less.
